(19) United States
(12) Patent Application Publication
(10) Pub. No.: US 2020/0214300 A1
(43) Pub. Date: Jul. 9, 2020

(54) COMPLEX ENZYME-CONTAINED FUNCTIONAL ORE POWDER AND PROCESS FOR PRODUCING THE SAME

(71) Applicant: Hanil Moolsan Co., Ltd., Busan (KR)

(72) Inventor: Soon-il LEE, Busan (KR)

(21) Appl. No.: 16/261,633

(22) Filed: Jan. 30, 2019

(30) Foreign Application Priority Data
Jan. 4, 2019 (KR) 10-2019-0001067

(51) Int. Cl. A01N 65/08; A01N 65/44; A01N 59/00; A01N 59/16; A01N 61/00; D06M 23/08; D06M 16/00; D06M 11/82; D06M 11/77; D06M 11/45; D06M 11/56

(52) U.S. Cl. CPC A01N 65/08; A01N 65/44; A01N 59/00; A01N 59/16; A01N 61/00; D06M 11/56; D06M 16/003; D06M 11/82; D06M 11/77; D06M 11/45; D06M 23/08

(57) ABSTRACT

The present invention relates to a complex enzyme-contained functional ore powder which can be used in textile products, particularly clothes such as socks, gloves, and undergarments, and bedding such as quilt, bed cover, and pillow cover; and a process for producing the same.

The complex enzyme-contained functional ore powder according to the present invention comprises, based on a total of 100 weight percent of the ore powder, 15 to 40% by weight of zeolite, 15 to 20% by weight of illite, 15 to 20% by weight of amphibole, 10 to 20% by weight of barley stone, 10 to 20% by weight of tourmaline, 5 to 15% by weight of terra alba, 4 to 10% by weight of biotite, and 1 to 5% of complex enzyme.

The complex enzyme-contained functional ore powder according to the present invention can remove odors such as ammonia, trimethylamine, methyl mercaptan, and hydrogen sulfide, and can inhibit pathogens, because the complex enzyme contained in the ore powder inhibits the growth of pathogens in the fabric product into which the ore powder containing the complex enzyme is fused or impregnated by a binder.

### CROSS-REFERENCE TO RELATED APPLICATIONS

This application claims priority to and the benefit of Korean Patent Application No. 10-2019-0001067, filed on Jan. 4, 2019, the disclosure of which is incorporated herein by reference in its entirety.

### FIELD OF THE INVENTION

The present invention relates to a complex enzyme-contained functional ore powder which can be used in textile products, particularly clothes such as socks, gloves, and undergarments, and bedding such as quilt, bed cover, and pillow cover; and a process for producing the same.

### BACKGROUND OF THE INVENTION

Textile products used for a long time in contact with human skin, particularly clothes such as socks, gloves and undergarments, and bedding such as quilt, bed cover, and pillow cover may be malodorous and may contain various pathogenic bacteria.

In general, there has been a technique of applying a mineral material emitting a far-infrared ray and an anion which have an antibacterial action to textile products. For example, Korean Patent 10-1064028 discloses a method for producing fabrics having far-infrared radiation, heat generating and temperature raising function, and fabrics produced thereby, wherein the method comprises a step of melting a specific content of silicon oxide, feldspar, borax, boric acid, potassium carbonate, niter, alumina hydroxide, limestone, barium carbonate, lithium, zircon, phosphoric acid, carbon and magnesium carbonate in a furnace at 1,300 to 1,600° C. simultaneously with stirring; a step of adding the melt into cooling water to be cooled and decomposed followed by pulverizing the melt into nano-sized particles, then mixing the melt with ionized water at a weight ratio of 5:5; a step of mixing the mixed solution with capsaicin in a weight ratio of 9:1 followed by adding a fabric thereto and heating and holding the mixed solution at 80 to 90° C. for 1 to 2 hours; and a step of heating and holding the mixed solution again at 30 to 40° C. for 30 to 40 minutes followed by dehydrating and drying.

However, antibacterial action is insufficient only by coating or mixing an mineral material emitting far-infrared rays and anions onto a fabric and the like as in the above-mentioned patent.

Therefore, there is a need for a complex enzyme-contained functional ore powder capable of releasing far infrared rays, anion and heat, removing odors, and inhibiting various pathogens, for fusing or impregnating the functional ore powder in the fabric.

### DETAILED DESCRIPTION OF THE INVENTION

### Problems to be Solved

An object of the present invention is to provide a complex enzyme-contained functional ore powder capable of releasing far infrared rays, anion and heat, removing odors, and inhibiting various pathogens for fusing or impregnating the ore powder in the fabric; and a process for producing the powder.

### Solution to the Problem

As a result of studying the above problem, the present inventors have found out that the above problem can be solved by providing a complex enzyme-contained functional ore powder having a specific composition, and have completed the present invention.

An aspect of the present invention provides a complex enzyme-contained functional ore powder comprising 15 to 40% by weight of zeolite, 15 to 20% by weight of illite, 15 to 20% by weight of amphibole, 10 to 20% by weight of barley stone, 10 to 20% by weight of tourmaline, 5 to 15% 5 to 15% by weight of terra alba, 4 to 10% by weight of biotite, and 1 to 5% of complex enzyme.

Another aspect of the present invention provides the complex enzyme-contained functional ore powder, wherein the complex enzyme is prepared by pulverizing fruit vegetables, leaf vegetables, root vegetables, grains, herbaceous plants, ivy tree (Dendropanax trifidus), red ginseng, and zeolite to nano-sized particles, mixing them with stirring, aging at a temperature 30 to 40° C. and a pH of 5.8 to 8.5 for 6 to 7 hours and then pulverizing them again.

Still another aspect of the present invention provides a process for producing the complex enzyme-contained functional ore powder, wherein the process comprises a step of attaching a silver foil to the mesh stainless steel located on the inner surfaces of inner furnace; a step of pulverizing zeolite, illite, amphibole, barley stone, tourmaline, terra alba, and biotite in the furnace; a step of heating the powder up to 1,000° C. by microwave; and a step of adjusting the pH of the powder to 8.5 or less followed by adding a complex enzyme thereto.

### Effects of the Invention

When the complex enzyme-contained functional ore powder according to the present invention is fused or impregnated by a binder into a fabric product that contacts human skin, especially clothes such as socks, gloves, underwear, etc., and bedding such as quilt, bed cover, pillow cover, etc., the ore powder can remove odors such as ammonia, trimethylamine, methyl mercaptan, and hydrogen sulfide, which are the cause of four odors, and can inhibit pathogens since the complex enzyme contained in the ore powder inhibits the growth of pathogens in the fabric product.

### BRIEF DESCRIPTION OF THE DRAWINGS

FIG. 1 is a schematic view of a furnace for producing the complex enzyme-contained functional ore powder of the present invention.

### THE BEST MODE FOR CARRYING OUT THE INVENTION

Hereinafter, preferred embodiments according to the present invention will be described in detail. However, it should be understood that the following embodiments are provided so that those skilled in the art can fully understand the present invention, and various modifications may be made without departing from the scope of the present invention. Accordingly, the scope of the present invention is not limited to the embodiments described below.

The present invention provides a complex enzyme-contained functional ore powder comprising, based on a total of 100 weight percent of the ore powder, 15 to 40% by weight of zeolite, 15 to 20% by weight of illite, 15 to 20% by weight of amphibole, 10 to 20% by weight of barley stone, 10 to 20% by weight of tourmaline, 5 to 15% by weight of terra alba, 4 to 10% by weight of biotite, and 1 to 5% of complex enzyme.

The zeolite used in the present invention is a porous crystalline material composed of silicon (Si) and aluminum (Al), which has a property of adsorbing heavy metals and toxic substances, adsorbs and removes wastes and fine dusts, and acts to inhibit the growth of microorganisms such as Escherichia coli, typhoid bacteria, and pyogenic bacteria.

The illite used in the present invention is a representative natural clay mineral, which is a porous mica mineral, and has a thin plate-like structure and is excellent in elasticity and adsorption because of its flexibility and elasticity. It also emits far infrared rays of 3.71×10² at an emissivity of 93% at 40° C. In addition, it has antibacterial activity and heavy metal adsorption performance.

The illite of the present invention is used in an amount of 15 to 20% by weight based on 100% by weight of the total ore powder. If the content is less than 15% by weight, the aimed deodorization and antibacterial activity of the present invention is insufficient. If the content is more than 20% by weight, the activity of the complex enzyme is lowered.

In addition, the amphibole used in the present invention is a black mineral containing calcium, magnesium and iron as main components and containing a small amount of aluminum and is also referred to as plagioclase. It was found that the amphibole emits a large amount of far-infrared rays and inorganic acids when it is heated. Especially, it emits 9 to 10 microns of far infrared ray (92% emissivity) which is beneficial to human body.

The amphibole of the present invention is used in an amount of 15 to 20% by weight based on 100% by weight of the total ore powder. If the content is less than 15% by weight, the aimed far infrared ray emission amount of the present invention is insufficient. If the content is more than 20% by weight, the far infrared ray is emitted more than necessary.

The barley stone used in the present invention is a mineral containing anhydrous silicic acid (SiO₂) and aluminum oxide (Al₂O₃) as main components and a small amount of various inorganic substances such as ferric oxide (Fe₂O₃). It has strong adsorption since it is composed of 30 to 150 thousand holes per 1 cm² and removes heavy metals since it acts to exchange ions with heavy metals. In addition, it emits far-infrared rays when it is heated.

The barley stone of the present invention is used in amount of 10 to 20% by weight based on 100% by weight of the total ore powder. If the content is less than 10% by weight, the aimed deodorization and far infrared ray emission amount of the present invention are insufficient. If the content is more than 20% by weight, the far infrared ray is emitted more than necessary.

The tourmaline used in the present invention is a polar crystal having the only permanent electrical characteristic among minerals and is called electric stone. The tourmaline is mainly composed of magnesium, iron, boron, silicon, and calcium, and it has been found that this ore generates anions, micro currents, and far infrared rays that are beneficial to the human body.

The tourmaline of the present invention is used in an amount of 10 to 20% by weight based on 100% by weight of the total ore powder. If the content is less than 10% by weight, the aimed deodorization and far-infrared ray emission amount of the present invention are insufficient. If the content is more than 20% by weight, far-infrared rays are excessively emitted.

The terra abla used in the present invention is a white clay mainly composed of silica, alumina, iron oxide, magnesium oxide, calcium oxide, and sodium oxide. When it is activated, it elute the soluble material to form fine pores having a specific surface area of 150 to 300 m²/g and a diameter of 30 to 50 Å, so that the adsorbability to polar materials, unsaturated materials and aromatic materials is excellent.

The terra abla used in the present invention is used in an amount of 5 to 15% by weight based on 100% by weight of the total ore powder. If the content is less than 5% by weight, the aimed deodorization and adsorption performance of the present invention is insufficient. If the content is more than 15% by weight, the activity of the complex enzyme is inhibited.

The biotite used in the present invention is a mineral containing small amounts of CaO, K₂O, Fe₂O₃, Na₂O, MgO, TiO₂, P₂O₅, MnO, etc. in addition to the main components SiO₂ and Al₂O₃. It has been found that it emits far-infrared rays (more than 93% of emissivity) at 40° C. to smooth the metabolism to the animals, and to have immunity enhancement, natural antibiotic and deodorizing activity.

The biotite used in the present invention is used in an amount of 4 to 10% by weight based on 100% by weight of the total ore powder. If the content is less than 4% by weight, the aimed deodorization and far-infrared rays emission of the present invention is insufficient. If the content is more than 10% by weight, infrared rays are excessively emitted and a problem occurs in activation of the complex enzyme.

In the present invention, the complex enzyme are added to the minerals to decompose ammonia, trimethylamine, methyl mercaptan and hydrogen sulfide, which are four odorous elements, and to rapidly decompose polymers such as lignin, thereby inhibiting pathogens. The content of the complex enzyme is 1 to 5% by weight based on 100% by weight of the total ore powder. If the content is less than 1% by weight, the effect of inhibiting harmful pathogens and deodorization is insufficient. If the content is more than 5% by weight, there is a problem that the complex enzyme is mixed with a large number of minerals and thus is not bound to an object but is released.

The complex enzyme used in the present invention can be prepared by pulverizing fruit vegetables, leaf vegetables, root vegetables, grains, herbaceous plants, ivy tree, red ginseng, and zeolite to nano-sized particles, mixing them simultaneously with stirring, aging them at a temperature of 30 to 40° C. and a pH of 5.8 to 8.5 for 6 to 7 hours, followed by pulverization.

The present invention also provides a process for producing the complex enzyme-contained functional ore powder, wherein the process comprises a step of attaching a silver foil to the mesh stainless steel located on the inner surfaces of inner furnace; a step of pulverizing zeolite, illite, amphibole, barley stone, tourmaline, terra alba, and biotite in the furnace; a step of heating the powder up to 1,000° C. by microwave; and a step of adjusting the pH of the powder to 8.5 or less, followed by adding a complex enzyme thereto.

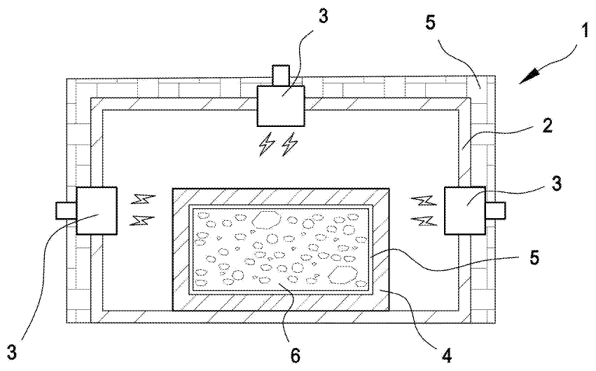

FIG. 1 shows a device 1 for producing the complex enzyme-contained functional ore powder of the present invention.

The device 1 for producing the ore powder according to the present invention is a hexahedron in which an electric heating plate 2 is lined, and a magnetron 3 is provided on the upper and side surfaces thereof. The inside of the electric heating plate 2 is provided with an internal furnace 4 which is an aluminum heating crucible and the outside thereof is surrounded by a heat insulating material 5. The inner surface of the inner furnace 4 is provided with a mesh stainless steel 6. A silver foil is attached to the stainless steel 6.

According to the present invention, the silver foil is attached to the mesh stainless steel of the inner furnace 4. Seven ores 7 of zeolite, illite, amphibole, barly stone, terra alba, tourmaline and biotite are introduced to the inner furnace 4 and pulverized to nano-sized particles. The pulverized mixture is heated to 1,000° C. by a heating plate 2 and a magnetron 3, and then the pH of the pulverized mixture is adjusted to 8.5 or less. Finally, the complex enzyme powder is added to the mixture to prepare a complex enzyme-contained functional ore powder.

Hereinafter, a process for producing the complex enzyme-contained functional ore powder of the present invention will be illustrated by way of examples.

### Example 1

30 g of zeolite, 15 g of illite, 15 g of amphibole, 15 g of barly stone, 10 g of tourmaline, 5 kg of terra alba and 4 g of biotite were pulverized to nano-sized particles to obtain 100 g of powder of seven ores.

Separately, 25 g of fruit vegetables, 10 g of leaf vegetables, 20 g of root vegetables, 5 g of grains, 20 g of herbaceous plant, 5 g of ivy tree, 5 g of red ginseng, and 10 g of zeolite 10 g were pulverized to nano-sized particles, mixed with stirring, aged at pH 5.8 to 8.5 for 6 to 7 hours, and then pulverized to obtain 5 g of complex enzyme.

95 g of the obtained powder of seven ores were introduced into the internal furnace 4, fused and heated up to 1,000° C. by the electric heating plate 2 and the magnetron 3, and cooled to room temperature, and controlled at pH 7. 5 g of the complex enzyme obtained above was mixed with the powder obtained above to prepare 100 g of the complex enzyme-contained functional ore powder according to the present invention.

### Test Example

Experiments were conducted to confirm the performance of the complex enzyme-contained functional ore powder prepared in Example 1 according to the present invention.

The following experiments were carried out in which a complex enzyme-contained functional ore powder of Example 1 was applied to a cloth of 40 cm×40 cm by a commonly used binder and a cloth (control) not coated with the ore powder of Example 1 was used for comparison.

### Experiment 1 (Deodorization Test)

According to KICM-FIR-1085, deodorization test was carried out using ammonia and the gas concentration was measured as FT-1R. The results are shown in Table 1 below.

TABLE 1

| | | Concentration | | |
|---|---|---|---|---|
| | Elapsed time | (ppm) | | Deodorization Rate |
| | (minute) | Example 1 | Control | (%) |
| Deodorization | 30 | 15 | 246 | 94 |
| Test | 60 | 3 | 217 | 99 |
| | 90 | 2 | 198 | 99 |
| | 120 | 2 | 183 | 99 |

### Experiment 2 (Far Infrared Radiation)

Far-infrared rays were measured in comparison with a black body using an FT-IR spectrometer at 40° C. The results are shown in Table 2 below.

TABLE 2

| Test Items | Example 1 | Control |
|---|---|---|
| Emissivity | 0.930 | 0 |
| (5-20 μm) | | |
| Radiation Energy | 3.75 × 10² | none |
| (W/m²) | | |

### Experiment 3 (Anion Emission)

According to KICM-FIR-1042, anions released under the conditions of an anion number of 18/cc in an atmosphere of a temperature of 22° C. and a humidity of 40% was measured as the number of ions per unit volume using a charge particle measuring apparatus. The results are shown in Table 3 below.

TABLE 3

| | Example 1 | Control |
|---|---|---|
| Anion | 550 | 0 |
| (number of ion/cc) | | |

As shown in Tables 1-3, the complex enzyme-contained functional ore powder of the present invention is excellent in deodorizing power, far-infrared ray emission and anion release. Accordingly, it can be also deduced that it has excellent antibacterial activity.

While the present invention has been described in detail with reference to exemplary embodiments thereof, it is to be understood that the invention is not limited to the disclosed exemplary embodiments. Therefore, the present invention can be variously modified by those skilled in the art without departing from the scope of the technical idea of the present invention.

### EXPLANATION OF REFERENCE NUMBER

1: device
2: electric heating plate
3: magnetron
4: inner furnace
5: heat insulating material
6: mesh stainless steel
7: ore materials

1. A complex enzyme-contained functional ore powder comprising, based on a total of 100 weight percent of the ore powder,
15 to 40% by weight of zeolite,
15 to 20% by weight of illite, 15 to 20% by weight of amphibole,
10 to 20% by weight of barley stone,
10 to 20% by weight of tourmaline,
5 to 15% 5 to 15% by weight of terra alba,
4 to 10% by weight of biotite, and
1 to 5% of complex enzyme.

2. The complex enzyme-contained functional ore powder according to claim 1, wherein the complex enzyme is prepared by pulverizing fruit vegetables, leaf vegetables, root vegetables, grains, herbaceous plants, ivy tree, red ginseng and zeolite into nano-sized particles, mixing them with stirring, aging at a temperature 30 to 40° C. and a pH of 5.8 to 8.5 for 6 to 7 hours and then pulverizing them again.

3. A process for producing the complex enzyme-contained functional ore powder, wherein the process comprises
a step of attaching a silver foil to the mesh stainless steel located on the inner surfaces of inner furnace;
a step of pulverizing zeolite, illite, amphibole, barley stone, tourmaline, terra alba, and biotite in the furnace;
a step of heating the powder up to 1,000° C. by microwave; and
a step of adjusting the pH of the powder to 8.5 or less followed by adding a complex enzyme thereto.
